(19) United States
(12) Patent Application Publication
(10) Pub. No.: US 2008/0190780 A1
(43) Pub. Date: Aug. 14, 2008

(54) ELECTROCHEMICAL PROCESSOR FOR HYDROGEN PROCESSING AND ELECTRICAL POWER GENERATION

(75) Inventor: Conghua Wang, West Windsor, NJ (US)

Correspondence Address: DLA PIPER US LLP;ATTN: PATENT GROUP, 500 8th Street, NW, WASHINGTON, DC, 20004-2131, US

(73) Assignee: TREADSTONE TECHNOLOGIES, INC., Princeton, NJ (US)

(21) Appl. No.: 12/019,507

(22) Filed: Jan. 24, 2008

Related U.S. Application Data
(60) Provisional application No. 60/886,508, filed on Jan. 24, 2007.

(51) Int. Cl. C25B 1/02

(52) U.S. Cl. 205/637; 204/424

(57) ABSTRACT

An apparatus and a method for generating hydrogen, the apparatus including a first electrode and a second electrode. The first electrode includes a catalytic material for promoting the formation of protons. The apparatus also includes a proton conductive electrolyte disposed between the first and second electrodes and a voltage source connected to the first electrode and to the second electrode. The voltage source is configured to provide a driving voltage having a base voltage and a pulsed voltage superposed on the base voltage to generate hydrogen. The apparatus has an input through which syngas or a hydrocarbon compound or both is introduced into the first electrode; and an output for discharging the generated hydrogen, the output being disposed opposite the input on an opposite side of the proton conductive electrolyte.

### CROSS-REFERENCE TO RELATED APPLICATIONS

This application is based on and claims priority to U.S. Provisional Patent Application No. 60/886,508, filed on Jan. 24, 2007, the contents of which are incorporated herein by reference.

### FIELD

The present invention relates to electrochemical processors that use proton conductive electrolyte to process hydrogen, including hydrogen generation, conversion, purification, separation and compression.

### BACKGROUND

Hydrogen can be an important chemical feedstock that is used in the synthesis of methanol, ammonia, urea, hydrochloric acid and other chemical products. It is also used as an intermediate energy carrier for energy conversion from various resources to meet the needs of both stationary and transportation markets. Currently, about 50 million tons/year of H₂ is produced worldwide, with 80% produced from natural gas.

Most fuel cell power systems use hydrogen as the fuel source. There are two ways to provide hydrogen to the fuel cell stacks. The first is to use a hydrogen storage device, such as high pressure hydrogen tank. The second is to integrate a fuel processor in the power system to generate hydrogen from hydrocarbon fuels.

Alternatively, some hydrocarbon fuels, such as methanol, formic acid, and ethanol can be directly used as the fuel for fuel cells for mobile applications. However, the performance of these fuel cells is not satisfactory.

Therefore, there is a need for hydrogen processing techniques that can efficiently process hydrogen. There is also a need for a compact fuel cell power system that can use hydrocarbon fuels for power generation.

### BRIEF DESCRIPTION OF THE DRAWINGS

FIG. 1 is a schematic diagram of an electrochemical device with a high voltage power source for hydrogen processing of hydrogen containing syngases, according to an embodiment of the present invention;

FIG. 2 is a schematic drawing of an electrochemical cell for hydrogen generation from hydrocarbon compounds, according to another embodiment of the present invention;

FIG. 3A shows a block diagram of a typical process for generating hydrogen;

FIG. 3B shows a block diagram of a process for generating hydrogen, according to an embodiment of the present invention;

FIG. 4A is a plot of experimental data of hydrogen purification using a NAFION® based proton exchange membrane (PEM) cell and Pt catalyst at room temperature, according to an embodiment of the present invention;

FIG. 4B shows an example of a driving voltage that can be applied across the hydrogen generator depicted in FIGS. 1 and 2, according to an embodiment of the present invention;

FIG. 4C shows a second example of a driving voltage that can be applied across the hydrogen generator depicted in FIGS. 1 and 2, according to an embodiment of the present invention;

FIG. 4D shows a third example of a driving voltage that can be applied across the hydrogen generator depicted in FIGS. 1 and 2, according to an embodiment of the present invention;

FIG. 5A shows a plot of the hydrogen flux expressed as an electrical current versus time, according to an embodiment of the present invention;

FIG. 5B depicts an example of a hydrogen generator using a feedback loop for optimizing the hydrogen production, according to an embodiment of the present invention; and

FIG. 6 is a schematic block diagram of an indirect methanol fuel cell (IMFC) power system, according to an embodiment of the present invention.

### DETAILED DESCRIPTION OF EMBODIMENTS

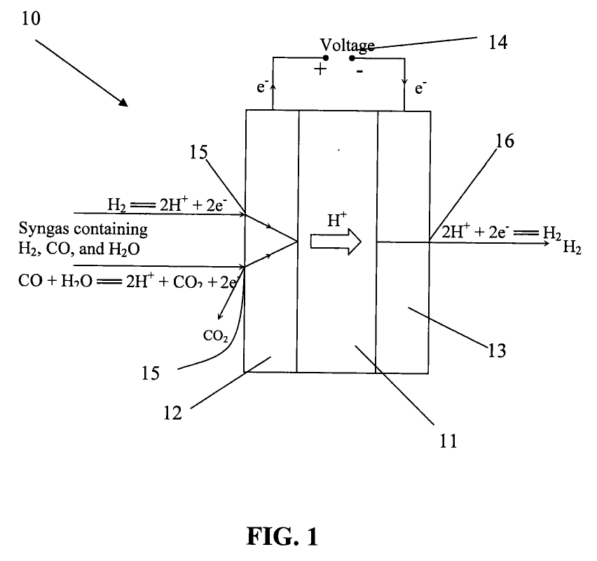

FIG. 1 is a schematic diagram of an electrochemical apparatus for processing of hydrogen containing syngases for hydrogen generation, according to an embodiment of the present invention. The electrochemical apparatus 10 comprises a proton exchange membrane (PEM) 11. The membrane 11 includes an electrolyte that mainly protons or protons with water can penetrate under a driving voltage. In one embodiment, the electrolyte is a polymer electrolyte membrane, such as NAFION® and polybenzimidazole (PBI). In another embodiment, the electrolyte is an acid such as a phosphoric acid or a mixture of acids. In yet another embodiment, the electrolyte is a proton conductive solid oxide. However, other materials can also be used as the electrolyte. The temperature for operation of the hydrogen generation apparatus 10 depends on the properties of the membrane 11. The operation temperature can be from room temperature to 800° C. The membrane 11 is sandwiched between two electrodes 12 and 13. The electrode 12 is the anode for H₂ and CO oxidization to generate protons. The anode includes a catalyst material such as platinum (Pt) for promoting the formation of protons. The electrode 13 is the cathode for hydrogen generation. Anode 12 and cathode are enclosed in separate chambers separated by the membrane 11. Anode 12 and cathode 13 are connected to power source 14 to provide a driving voltage to the electrochemical apparatus 10. The driving voltage can be a continuous voltage, a pulsed voltage, or a combination of both.

Syngases containing a mixture of hydrogen (H₂), carbon monoxide (CO) and water (H₂O) and possibly other compounds are processed through one or more inputs 15 the apparatus 10 to generate substantially pure H₂. This involves passing the syngases via the one or more inputs 15 and flowing the syngases through the anode 12 to generate protons H⁺. The generated protons H⁺ are then selectively passed through the membrane 11 and subsequently combined with electrons supplied via the cathode 13 in a reduction reaction to obtain substantially pure H₂. The obtained substantially pure hydrogen is discharged through one or more outputs 16 of the apparatus 10. In addition, to the pure hydrogen, some water can also be discharged through the one or more outputs 16. As shown in FIG. 1, the one or more inputs 15 and the one or more outputs 16 are located on opposite sides of the membrane 11.

In parallel with passing hydrogen through the electrolyte, CO in the syngases could be absorbed on the anode 12 and the react with water on the anode 12 to generate protons. The protons will pass through the membrane electrolyte 11 to subsequently combine with electrons supplied via the cathode 13 in a reduction reaction to obtain substantially pure H₂. The process of passing syngases through apparatus 10 converts CO to CO₂ and generates and purifies hydrogen in one step, i.e., substantially simultaneously. The apparatus 10 can also be configured to also compress hydrogen at the same time with a proper mechanical design to handle high pressure. Alternatively, the obtained hydrogen can be compressed or further compressed using a compressor (not shown) separate from the apparatus 10. The apparatus 10 for the hydrogen generation from syngases or hydrocarbon compounds, or both can be used, for example, as the hydrogen source for an electrical power system. The hydrocarbon compounds can be methanol, ethanol, formic acid or other compounds. The hydrogen generation apparatus 10 can be integrated with electrical power generation devices, such as fuel cells or combustion engines. A portion of the electrical power generated by the electrical power generators can be used to drive the hydrogen generation apparatus and other components in the system. The balance of the electrical power is used as the output power.

The presence of carbon monoxide (CO) in the syngases can be responsible in a sluggish performance of the anode. Indeed, the carbon monoxide can be absorbed by the catalyst or adsorbed on the catalyst (typically platinum Pt and/or platinum Pt alloys) surface of the anode 12 which can cause a degradation of the anode 12 catalytic activities. This is known as “CO poisoning” of the anode catalyst. The carbon monoxide can come from different sources. The carbon monoxide can be a major content in the syngas mixture, an impurity in the syngas mixture, or can also be an intermediate product of the anode reaction with hydrocarbon compounds. The following chemical equations show the processes by which carbon monoxide can be absorbed by or adsorbed on the catalyst electrode (anode 12).

Equation (1) shows a process by which carbon monoxide gas (CO_{gas}) is adsorbed into the catalyst electrode (e.g., Pt catalyst) to obtain a catalyst with adsorbed CO (Pt—CO_{ads}).

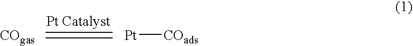

Equations (2) shows the carbon monoxide adsorption reaction as an intermediate product of the electrode reaction of hydrocarbon compounds (e.g., methanol CH₃OH):

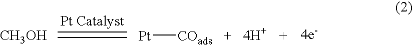

The catalyst can be pure Pt, Pt alloys or other materials. Equation (2) depicts the reaction of methanol with the catalyst, however, the hydrocarbon compounds can be any other alcohol (e.g., ethanol), an organic acid such as formic acid, an alkane such as methane, an alkene such as ethylene or others compounds, or any combination of two or more thereof. Both reactions (1) and (2) depict ways by which the catalyst in the anode 12 becomes poisoned by carbon monoxide which leads to a reduction in the catalytic activity of the catalyst (e.g. platinum).

In one embodiment, a process can be provided in which a relatively high activity of electrode catalyst for electrode reactions can be maintained by regenerating the catalytic activity of the anode by stripping the carbon monoxide or converting the carbon monoxide into carbon dioxide. The relatively high activity can be maintained by applying a relatively high electrical voltage greater than 0.4V/cell, for example greater than 0.6V/cell. For example, the relatively high activity of electrode catalyst can be maintained by applying voltage pulses on proton conductive electrolyte based electrochemical apparatus 10 (cell) to generate the hydrogen via conversion processes, purification processes, separation processes and compression processes. Although the apparatus 10 is described herein having one cell for generating hydrogen, a plurality of cells can be arranged as a stack of cells, in series or in parallel to constitute the hydrogen generation apparatus. The relatively high voltage can be applied either as a consistent continuous voltage during the whole process, or as voltage pulses with relatively high amplitudes, with or without lower base voltages. As will be discussed in further detail below, in embodiments in which voltage pulses are employed, the voltage pulses are preferably periodic with a period such that a voltage pulse is applied before hydrogen production is significantly impaired by CO poisoning subsequent to the previous pulse.

Under the relatively high voltage, oxygen containing species, such as hydroxyl group OH adsorbed on Pt catalyst (Pt—OH_{ads}), can be generated on the anode catalyst surface, as shown in the following chemical reaction.

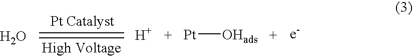

The generated oxygen containing species (e.g., Pt—OH_{ads}) can react with the absorbed or adsorbed CO on the catalyst surface to strip the carbon monoxide (CO) off of the catalyst (e.g., Pt catalyst), as shown in the following reaction (4).

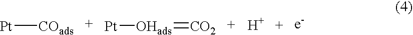

The whole CO stripping electrode reaction is a combination of equation (3) and equation (4) and can be expressed by the following equation (5).

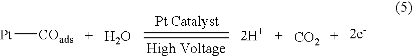

The above chemical reactions describe the adsorption of the carbon monoxide on the anode catalyst 12 and the stripping of the carbon monoxide from the anode catalyst 12. The anode catalyst 12 is used to oxidize the hydrogen in the gas mixture to generate protons H⁺ as shown by the following equation (6). This process of proton formation can occur substantially simultaneously during the CO stripping from the anode 12.

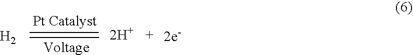

The protons generated, as shown in the reaction (5), are transported through the proton conductive electrolyte membrane 11 and subsequently reduced back to molecular hydrogen (H₂) on the cathode 13 which supplies electrons. The reduction reaction of the protons occurs by combining the protons with the electrons supplied via the cathode 13, as shown by following equation (7).

2H⁺+2e⁻=H₂ (7)

The overall reactions for CO and H₂ containing gas mixtures can be summarized by the following two equations (8) and (9). Specifically, carbon monoxide (CO) conversion reaction (8) is obtained through the sum (equation (1)+equation (5)+equation (7)):

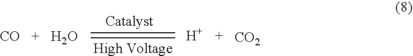

and hydrogen separation reaction (9) is obtained through the sum (equation (6)+equation (7)).

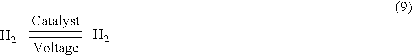

The overall reaction for hydrocarbon molecules, for example, methanol (CH₃OH), can be expressed by equation (10) as (equation (2)+equation (6)+equation (7)):

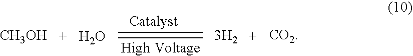

As stated above, protons can penetrate through the proton conductive electrolyte 11 to reach cathode 13 where they are reduced to hydrogen in the cathode chamber that is separated from the chamber of the anode 12 where CO₂ is generated, as shown FIG. 1. As a result, substantially pure hydrogen can be produced in the cathode chamber of cathode 13 which can be released through output 16.

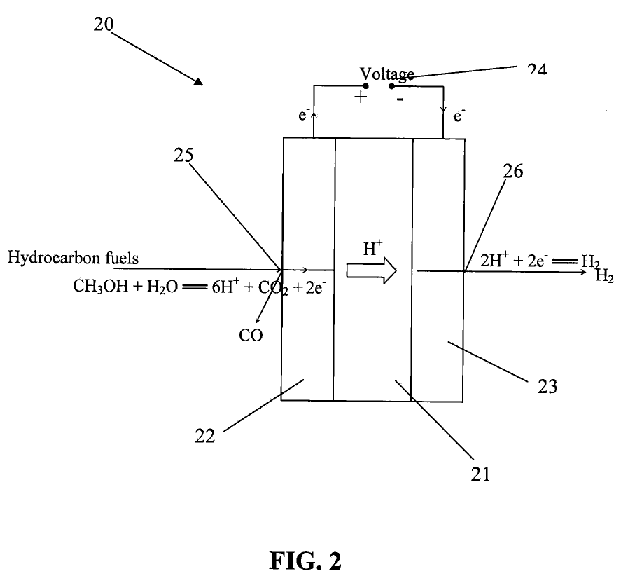

FIG. 2 is a schematic drawing of an electrochemical cell for hydrogen generation from hydrocarbon compounds, according to another embodiment of the present invention. Similar to the apparatus 10 depicted in FIG. 1, the electrochemical apparatus 20 comprises a proton exchange membrane (PEM) 21. The membrane 21 includes an electrolyte that mainly protons can penetrate under a driving voltage. The membrane 21 is sandwiched between two electrodes 22 and 23. The electrode 22 is the anode for H₂ and CO oxidization to generate protons. The electrode 23 is the cathode for hydrogen generation. Anode 22 and cathode 23 are connected to power source 24 to provide a driving voltage to the electrochemical apparatus 20. The driving voltage can be a continuous voltage, a pulsed voltage, or a combination of both.

Processing hydrocarbon compounds, such as methanol, through apparatus 20 conducts the hydrogen generation and purifies the hydrogen in one step. It can also compress hydrogen in the same step with a proper mechanical design of the apparatus 20 to handle high pressure.

Hydrocarbon fuels including CH₃OH are introduced through input 25 on the anode side 22 of the apparatus 20 to be processed by the apparatus 20 to produce hydrogen. The produced hydrogen is discharged through output 26 disposed on the cathode side 23 of the apparatus 20. The overall process taking place in the apparatus 20 can be summarized by the following equation (11).

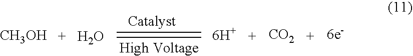

The electrons are re-circulated from the anode 22 to the cathode 23 and supplied back to the protons H⁺ which traversed the membrane (PEM) 21 containing the electrolyte to combine with the protons to form the hydrogen molecule H₂ in the chamber of the cathode 23. The formed hydrogen is then output through output 26.

Typical industrial hydrogen production is implemented through a multi-step thermal chemical process to reform hydrocarbon fuels to hydrogen. The typical processing routes involve thermal chemical process to convert hydrocarbon compounds to syngases (the mixtures of hydrogen, CO, CO₂, H₂O, and others) in the reforming step, and then go through several more steps including, water-gas-shift (WGS) step to convert CO to additional hydrogen, purification step to separate pure hydrogen from the gas mixture, and compression step to compress the pure hydrogen to high pressure for storage and transportation. The whole process is complicated and costly.

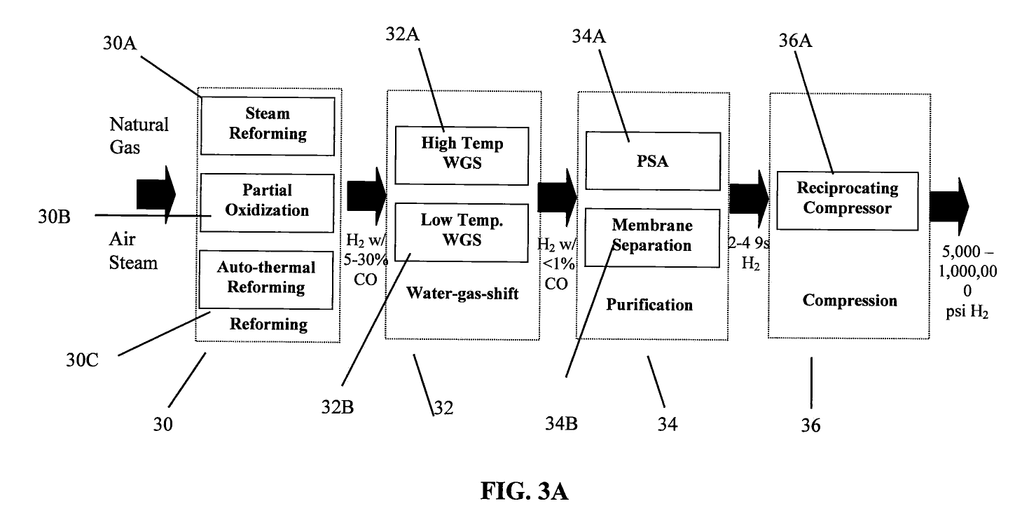

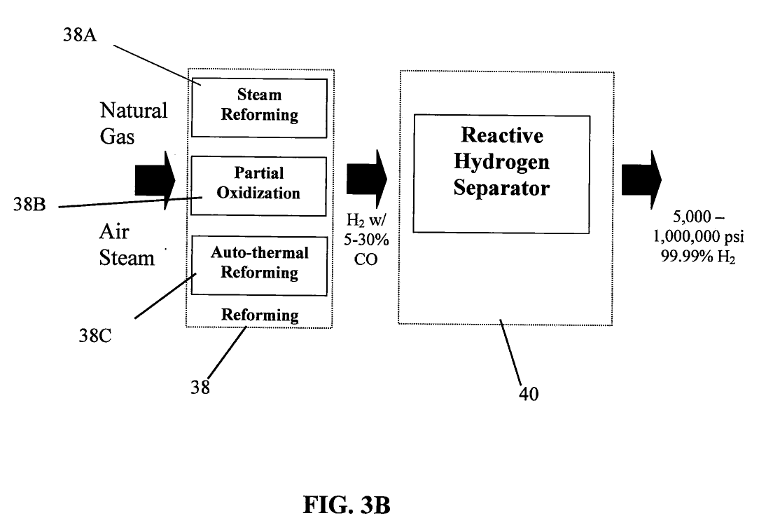

FIG. 3A shows a block diagram of a typical process for generating hydrogen. As shown in FIG. 3A, the typical processing routes include a reforming step (steam reforming) 30, a water-gas-shift (WGS) step 32, a purification/separation step 34, and compression step 36. The reforming step 30 can use one or more of a plurality of procedures including steam reforming 30A, partial oxidization 30B and auto-thermal reforming 30C. The WGS step 32 can use one or more of a plurality of methods including as high temperature WGS 32A and low temperature WGS 32B. The purification step 34 can use one or more of a plurality of methods including pressure swing adsorption (PSA) 34A and membrane separation 34B. The compression step 36 can use one or more of known compression methods such as reciprocating compression 36A.

FIG. 3B shows a block diagram of an improved process for generating hydrogen. As shown in FIG. 3B, the improved process for generating hydrogen has fewer steps in comparison with the process depicted in FIG. 3A. This embodiment can simplify the hydrogen production by consolidating all, or some of the steps described above with respect to FIG. 3A into one step. As shown in FIG. 3B, the water-gas-shift (WGS) step, the purification (separation) step and/or the compression step can be consolidated into one step using an electrical driven, proton conductive electrolyte based, electrochemical reactive hydrogen separator. As shown in FIG. 3B, the hydrogen processing includes a reforming step 38, such as steam reforming 38A, partial oxidization 38B and/or auto-thermal reforming 38C, and a reactive separation step 40 using the electrochemical reactive hydrogen separator or hydrogen reactor of the present invention.

As described in the above paragraphs, the hydrogen generator which can comprise one or more cells can use a high voltage applied continuously or by pulses to convert CO to hydrogen, purify hydrogen and optionally compress hydrogen to high pressure for hydrogen storage and delivery. In one embodiment the voltage is greater than 0.4V/cell, for example greater than 0.6V/cell.

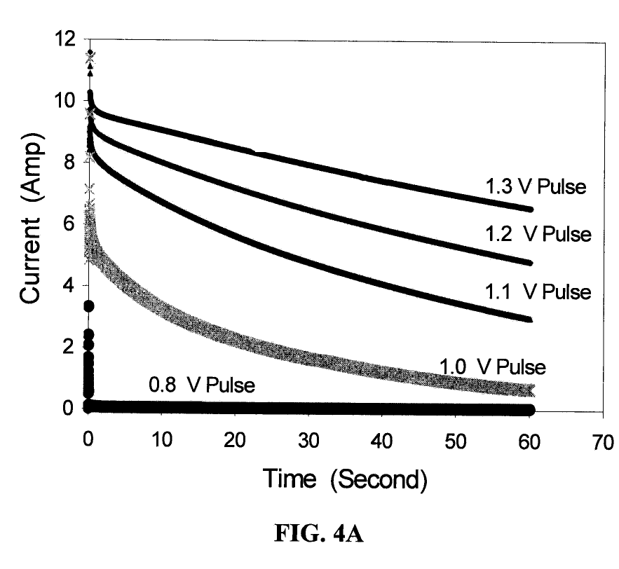

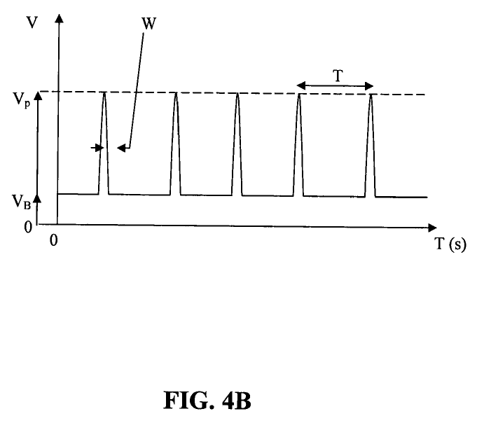

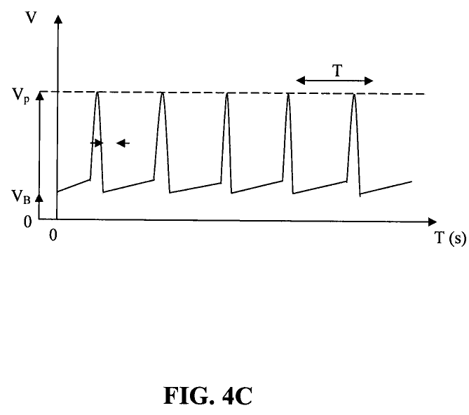

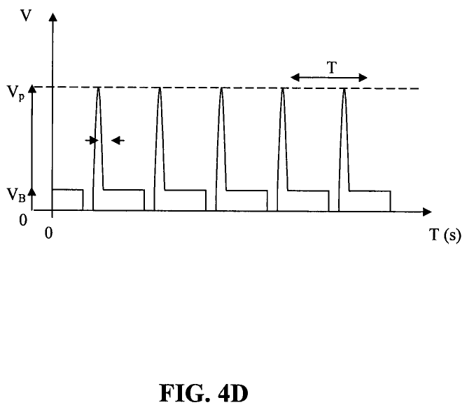

FIG. 4A is a plot of experimental data of hydrogen purification/generation using a NAFION® based proton exchange membrane (PEM) cell and Pt catalyst at room temperature, according to an embodiment of the present invention. In one embodiment, the hydrogen generator can have an active area of about 15 cm² and can separate pure hydrogen from hydrogen containing 105 ppm CO impurity under a driving voltage. The ordinate axis represents the flux of hydrogen generated which is expressed in this plot as an electrical current. The abscissa axis represents the time in seconds corresponding to the time elapsed after application of the driving voltage across the hydrogen generation apparatus. The hydrogen flux expressed as an electrical current is plotted as a function of time at various driving voltages.

The hydrogen flux under continuous 0.2 V driving voltage (not shown in this figure) is negligible (approximately 45 mA electrical current) due to the CO poisoning of the Pt catalyst. When a short voltage pulse of 0.8 V amplitude and 30 ms width is superposed on the 0.2 V base voltage (V_{B}), the hydrogen flux increases slightly as evidenced by an electrical current of approximately 0.1 A through the electrodes (the current is proportional to hydrogen production). However, when a short voltage pulse with an amplitude of approximately 1 V to 1.3 V with a 30 ms width superposed on the 0.2 V base voltage is applied, the hydrogen flux increases dramatically as evidenced by an electrical current in the range of about 4 A to about 10 A. The hydrogen flux slowly decays to about 0.5 A in one minute (60 seconds) for a driving voltage pulse of approximately 1 V and decays to 6.3 A in one minute (60 seconds) for a driving voltage pulse of approximately 1.3 V. This decay is due to the slow carbon monoxide adsorption (CO poison) on the catalyst. As shown in FIG. 4A, the higher is the amplitude of the voltage pulse, the slower is the decay of the hydrogen flux with time. Using the data in FIG. 4A, the ratio of current measured at the end of the voltage pulse, i.e., at a time equal to 30 milliseconds (when the CO poisoning is at a minimum), to current measured at approximately 60 seconds (i.e., just prior to the next pulse), can be calculated. This ratio is about 70% for a driving voltage pulse of about 1.3 V, about 50% for a driving voltage pulse of about 1.2 V, about 30% for a driving voltage pulse of about 1.1 V, and about 10% for a driving voltage pulse of about 1.0 V. However, the rate of decrease of hydrogen generation can depend on may factors and parameters including the fuels (e.g., hydrocarbons) used, the geometry of the hydrogen generation cell including the surface area of anode, the type of membrane used, and the applied driving voltage including the duty cycle of the voltage pulses, the amplitude of the voltage pulses, the width of the voltage pulses, etc.

The plot in FIG. 4A indicates that short, high voltage pulses can maintain the catalyst activities for the hydrogen purification. The activation voltage can be related to the properties of the catalyst. For platinum used as a catalyst, it appears that the “stripping” voltage must be higher than 0.8V/cell. However, other catalysts may operate at higher or lower voltage than that of platinum.

FIG. 4B shows an example of a driving voltage that can be applied across the hydrogen generation cell 10, 20 described in the above paragraphs, according to an embodiment of the present invention. As shown in FIG. 4B, the driving voltage is a train of voltage pulses (V_{P}) with a width (W) superposed on a base voltage (V_{B}). The train of voltage pulses has a period T. The base voltage V_{B} can be any voltage greater than 0, for example in the range between about 0.01 V and about 0.5 V such as 0.2 V. The base voltage shown in FIG. 4B is constant. As will be discussed in further detail below, the base voltage is non-constant and even non-continuous in other embodiments. The peak voltage Vp is selected to be greater than 0.4 V, for example in the range between about 0.4 V and about 2.0 V. In one embodiment, the voltage Vp can be from about 1.0V to about 1.3V, as shown above in FIG. 4A. The period T can be selected so as to maintain a certain hydrogen production. For example, the period T can be set such that, after application of a voltage pulse, a subsequent voltage pulse occurs when the hydrogen production decays to a ratio in the range between about 30% and about 99%, or, in some embodiments, between about 50% and 99%. For example, in one embodiment, the period can be selected to be one second. Hence, with respect to FIG. 4A, after application of a voltage pulse of 1.3 V at time equal 0, a subsequent pulse of 1.3 V can be applied one second later so as prevent a decay of a hydrogen production below, for example, 90% of the peak hydrogen production.

As discussed above, the base voltage need not be constant as shown in FIG. 4B. In some embodiments, the base voltage varies. For example, FIG. 4C illustrates a waveform in which the base voltage slowly rises during the period between successive high voltage pulses. In still other embodiments, the voltage may decrease during the period between successive high voltage pulses. It is also possible for the base voltage to be discontinuous. As one example, FIG. 4D illustrates a waveform in which the base voltage is discontinuous and no voltage is supplied for a short period immediately preceding each high voltage pulse. In yet other embodiments, the period of no voltage may immediately follow the high voltage pulse. In still other embodiments, the base voltage cycles on and off multiple times during the period between high voltage pulses. Other variations on the base voltage are also possible. It should also be noted that other changes to the wave form in FIG. 4B are also possible. For example, the time between high voltage pulses can be varied periodically or otherwise. The amplitude of high voltage pulse can also be varied.

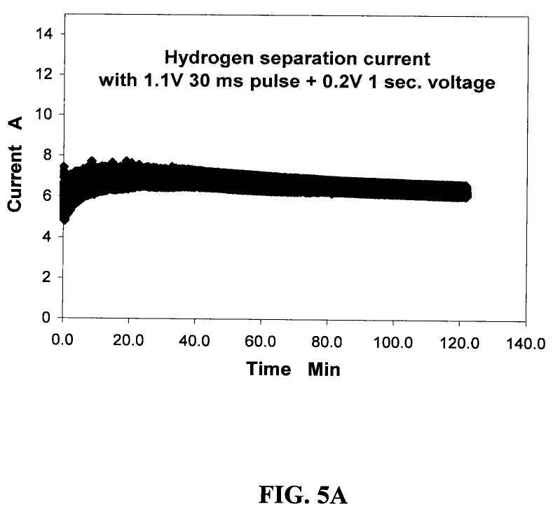

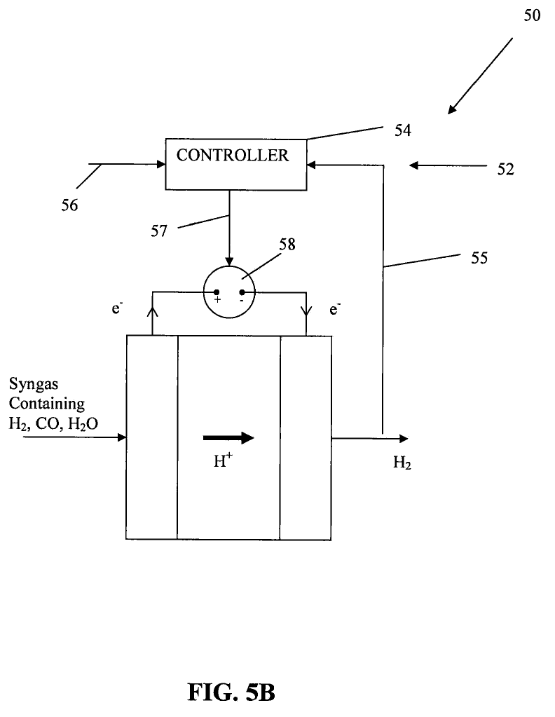

FIG. 5A shows a plot of the hydrogen flux expressed as an electrical current versus time, according to an embodiment of the present invention. FIG. 5A shows a continuous operation of the hydrogen purifier for about 2 hours (120 minutes). The continuous operation of the hydrogen purification is performed using a cell with an active area of about 15 cm² and to purify hydrogen containing 105 ppm CO impurity. A periodic pulsed voltage with an amplitude (Vp) of about 1.1 V, a width (W) of about 30 ms, and a period (T) of about 1 second superposed on a base voltage of about 0.2V, is applied on the hydrogen generation cell for about two hours (120 minutes). A stable hydrogen flux is obtained from the CO containing gas. This flux is comparable to a hydrogen flux obtained using CO free hydrogen.

As described in the above paragraphs, parameters of the driving voltage including the amplitude (Vp) of the peak voltage, the width (W) of the peak voltage and/or the period (T) of the train of voltage pulses can be selected so as to achieve a certain hydrogen production rate or threshold or other desired output. This can be done either manually by selecting the appropriate value for each parameter (voltage peak amplitude, width, period) to achieve a desired hydrogen output or automatically by using a feedback loop which would use a measured hydrogen output or other parameter and optimize or tune any one or more of these three parameters to obtain or maintain the desired output.

FIG. 5B depicts an example of a hydrogen generator using a feedback loop for optimizing the hydrogen production, according to an embodiment of the present invention. The hydrogen generator 50 is similar in any many aspects to the hydrogen generators 10, 20 described above with respect to FIGS. 1 and 2. However, in addition to the cathode, anode, the proton membrane, and the voltage source, the hydrogen generator 50 further includes a feedback loop 52. The feed back loop 52 includes a controller 54 such as, for example, a proportional-integral-derivative (PID) controller. The controller 52 receives a signal through line 55 proportional to the amount of hydrogen output by the hydrogen generator 50. In one embodiment, the amount of hydrogen output by the hydrogen generator 50 can be compared to a threshold value (hydrogen amount) selected by a user and input into the controller 54 via set-input 56. The controller is configured to produce a signal or signals which are input via line 57 into the voltage source 58 to control the driving voltage across the hydrogen generator, for example, by varying or adjusting at least one of the parameters of the voltage (e.g., voltage pulse amplitude, pulse width, period) so that the hydrogen generator delivers a hydrogen amount greater or equal to the threshold value selected by the user. In another embodiment, the user does not need to input a threshold value into the controller 54, and the controller 54 automatically adjusts the value of one or more of the parameters (voltage pulse amplitude, period, pulse width) so as to maximize the hydrogen output and/or the overall efficiency of the system. In yet another embodiment, instead or in addition to measuring the hydrogen output by the hydrogen generator 50 and inputting a signal proportional to that hydrogen output, an ion detector can be disposed in the proton exchange membrane (PEM) and a signal proportional to a proton flux is input into the controller 54. The controller 54 can employ the proton signal as a feedback control signal to vary one or more of the parameters (voltage pulse amplitude, period, pulse width) to control the amount of hydrogen produced by the hydrogen generator 52 in same manner described above.

Water electrolysis can be performed to generate and compress hydrogen, with the assistance of hydrocarbon compounds, according to an embodiment of the present invention. The hydrocarbon compound can be, for example, an alcohol such as methanol, ethanol, etc. or any combination thereof. Additionally or alternatively, other hydrocarbon compounds, such as formic acid and biogas can also be used. The use of a hydrocarbon compound in a water electrolyzer, according to an embodiment of the present invention, can save electrical energy consumption by about 70% as compared to a conventional water electrolyzer.

Table 1 shows a comparison between a conventional water electrolyzer and an example of a water electrolyzer according to an embodiment of the present invention.

TABLE 1

| | | | Example of a Water Electrolyzer |
|---|---|---|---|
| | | Conventional Water | according to an embodiment of the |
| | | Electrolyzer | present invention |
| Anode | Reaction | H₂O═2H⁺ + ½O₂ + 2e⁻ | CH₃CH₂OH + 3H₂O═12H⁺ + 2CO₂ + 12e⁻ |
| | E⁰_{Anode} | E₀: 1.23 V | E₀: 0.08 V |
| Cathode | Reaction | 2H⁺+ 2e⁺═H₂ | 2H⁺+ 2e⁺═H₂ |
| | E⁰_{Cathode} | E₀: 0 V | E₀: 0 V |
| Overall | Reaction | H₂O═H₂ + ½O₂ | CH₃CH₂OH + 3H₂O═6H₂+ 2CO₂ |
| | E⁰ | E₀: 1.23 V | E₀: 0.08 V |

As shown in Table 1, in a conventional water electrolyzer, the reaction at the anode side is H₂O=2H⁺+½/O₂+2e⁻, and the reaction at the cathode side is 2H⁺+2e⁺=H₂ providing an overall reaction equation H₂O═H₂+½O₂. On the other hand, in the example of a water electrolyzer according to an embodiment of the present invention, the reaction at the anode side is CH₃CH₂OH+3H₂O=12 H⁺+2CO₂+12e⁻, and the reaction at the cathode side is 2H⁺+2e⁺=H₂ providing an overall reaction equation CH₃CH₂OH+3H₂O=6H₂+2CO₂, when ethanol (CH₃CH₂OH) is used as the hydrocarbon compound for assisting the electrolysis.

Using hydrocarbon compounds, such as ethanol, in the anode reaction can replace oxygen evolution reaction with CO₂ generation reaction. In addition, the theoretical reversible potential of the electrolysis reaction (E⁰) is reduced from 1.23V for conventional water electrolysis to 0.08V for ethanol solution electrolysis. Therefore, the average operation voltage of the electrolyzer can be reduced from about 1.6V/cell or 1.7V/cell for the conventional water electrolyzer to about 0.5V/cell for the water electrolyzer of the present invention, in this example. This may result in a significant electrical energy saving.

The technical barrier for ethanol solution electrolysis is the slow anode oxidization activity of ethanol under normal operation conditions. This invention discloses the method to use the high voltage, or high voltage pulses to maintain the high activity of electrode catalyst for the hydrogen production. In one embodiment, the peak voltage is greater than 0.4V/cell, for example greater than 0.6V/cell.

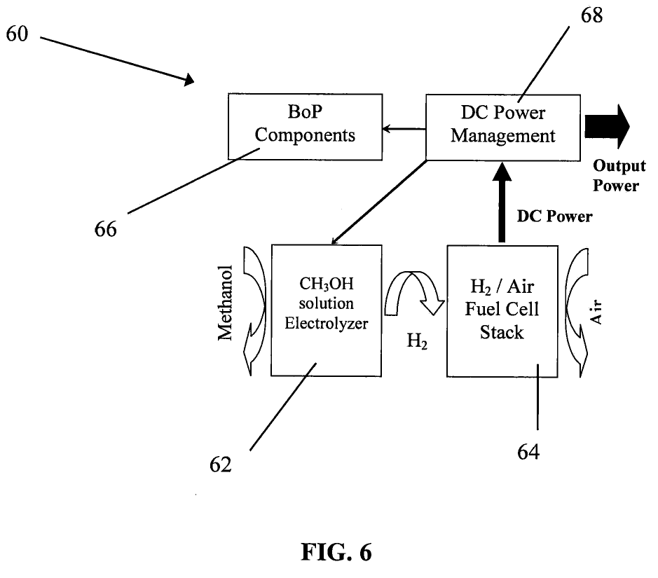

FIG. 6 is a schematic block diagram of an indirect methanol fuel cell (IMFC) power system, according to an embodiment of the present invention. Typical methanol fueled fuel cells use methanol directly on the anode for electrical power generation. However, there are some technical barriers, such as sluggish anode activity, low energy efficiency due to the methanol cross over, and complicated system integration. As shown in FIG. 6, the methanol fuel cell power system 60 includes a methanol electrolyzer 62, a plurality of fuel cells 64, balance of plant (BOP) components 66, and DC power management 68. In this embodiment, methanol is converted into substantially pure hydrogen in the electrolyzer 62. The hydrogen is then fed into PEM fuel cells 64 and mixed with air for the electrical power generation. Under the control by the DC power management 68, a portion of the electrical power generated in the system is diverted back into the system and used in the electrolyzer 62 for the hydrogen generation and system control. The balance or remaining electrical power is used as the output power. Those of skill in the art will recognize that the DC power management module 68 can employ a feedback loop to optimize power generation. This indirect use of methanol for the fuel cell can generate electricity more efficiently while using a compact system. One possible application of this methanol based power system could be for use as a portable power source for electronic devices or other electrically powered devices.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

Moreover, the method and apparatus of the present invention, like related apparatuses and methods used in the electrochemical arts are complex in nature, are often best practiced by empirically determining the appropriate values of the operating parameters, or by conducting computer simulations to arrive at best design for a given application. Accordingly, all suitable modifications, combinations and equivalents should be considered as falling within the spirit and scope of the invention.

In addition, it should be understood that the figures, are presented for example purposes only. The architecture of the present invention is sufficiently flexible and configurable, such that it may be utilized in ways other than that shown in the accompanying figures.

What is claimed is:

1. An apparatus for generating hydrogen, comprising:
a first electrode and a second electrode, the first electrode including a catalytic material for promoting the formation of protons;
a proton conductive electrolyte disposed between the first and second electrodes;
a voltage source connected across the first electrode and the second electrode, the voltage source being configured to provide a non-zero driving voltage having a base voltage and a pulsed voltage superposed on the base voltage to generate hydrogen;
an input through which a hydrocarbon compound, a syngas, or a combination thereof is introduced into the first electrode; and
an output for discharging the generated hydrogen, the output being disposed on a side of the proton conductive electrolyte opposite the input.

2. The apparatus of claim 1, wherein the first electrode is an anode and the second electrode is a cathode.

3. The apparatus of claim 1, wherein the proton conductive electrolyte comprises a proton exchange membrane.

4. The apparatus of claim 1, wherein the proton conductive electrolyte comprises NAFION®, polybenzimidazole, phosphoric acid, or a proton conductive solid oxide.

5. The apparatus of claim 1, wherein the syngas comprises hydrogen, carbon monoxide and water.

6. The apparatus of claim 1, wherein the hydrocarbon compound includes an alcohol, an organic acid, an alkane, or an alkene, or any combination of two or more thereof.

7. The apparatus of claim 1, wherein the catalytic material includes platinum.

8. The apparatus of claim 1, wherein the first electrode is located in a first chamber, the second electrode is located in a second chamber, and the first chamber and the second chamber are separated by the proton conductive electrolyte.

9. The apparatus of claim 1, wherein the base voltage is a constant voltage between pulses of the pulsed voltage.

10. The apparatus of claim 9, wherein the constant voltage is approximately 0.2 Volt.

11. The apparatus of claim 1, wherein the pulsed voltage is a train of voltage pulses having an amplitude greater than approximately 0.4 V.

12. The apparatus of claim 11, wherein a width of the voltage pulses is approximately 30 milliseconds and a period of the train of voltage pulses is approximately one second.

13. The apparatus of claim 1, further comprising a controller, the controller being configured to control the voltage source based upon an input signal proportional to the generated hydrogen.

14. The apparatus of claim 13, wherein the input signal to the controller is proportional to a current flowing through one of the first electrode and the second electrode.

15. The apparatus of claim 13, wherein the controller is further configured to automatically adjust a parameter of the voltage source so as to maximize the hydrogen generated.

16. The apparatus of claim 1, wherein the apparatus is further configured to compress the generated hydrogen.

17. The apparatus of claim 1, wherein the apparatus is further configured to purify hydrogen.

18. The apparatus of claim 1, wherein the apparatus is configured to generate, purify and compress hydrogen substantially simultaneously.

19. A method of producing hydrogen, comprising:
flowing a syngas, a hydrocarbon compound or a combination thereof through an input of a hydrogen generator including a first electrode having a catalytic material for adsorbing carbon monoxide, a second electrode spaced apart from the first electrode and a proton conductive electrolyte disposed therebetween;
applying a driving voltage on the first electrode and the second electrode across the proton conductive electrolyte to convert carbon monoxide that has adsorbed on the catalytic material to carbon dioxide to regenerate an adsorption capacity of the catalytic material and to generate hydrogen at an output of the hydrogen generator, the driving voltage including a base voltage and a pulsed voltage superposed on the base voltage.

20. The method of claim 19, wherein the flowing of the syngas comprises flowing hydrogen, carbon monoxide and water.

21. The method of claim 19, wherein the flowing of the hydrocarbon compound includes flowing an alkane, an alkene, an alcohol, or an organic acid, or any combination of two or more thereof.

22. The method of claim 19, wherein the applying of the driving voltage includes applying a train of pulses across the first electrode and the second electrode.

23. The method of claim 19, further comprising controlling the driving voltage so as to achieve a desired hydrogen output.

24. The method of claim 23, wherein the controlling of the driving voltage comprises controlling the driving voltage based upon an input signal proportional to the generated hydrogen.

25. The method of claim 19, further comprising compressing the generated hydrogen.

26. The method of claim 19, further comprising purifying hydrogen using the hydrogen generator.

27. The method of claim 19, further comprising generating, purifying and compressing hydrogen using the hydrogen generator substantially simultaneously.
